(19) United States
(12) Patent Application Publication
(10) Pub. No.: US 2025/0371515 A1
(43) Pub. Date: Dec. 4, 2025

(54) ANONYMITY-ENABLED TRANSMISSION OF NOTIFICATIONS WITHOUT EXCHANGING CONTACT IDENTIFIERS

(71) Applicant: PAYPAL, INC., San Jose, CA (US)

(72) Inventors: Eduardo Alejandro Solana Lopez, Danderyd (SE); Paul Robert Etienne Ostonen Peelen, Ingarö (SE)

(21) Appl. No.: 18/733,305

(22) Filed: Jun. 4, 2024

(51) Int. Cl. G06Q 20/32; G06Q 20/36

(52) U.S. Cl. CPC G06Q 20/322; G06Q 20/36

(57) ABSTRACT

There are provided systems and methods for anonymity-enabled transmission of pager notifications without exchanging contact identifiers. A user may engage in a transaction with another user, such as a purchase of goods, services, or other items from a merchant at a physical merchant location. The merchant may provide options to receive a notification when an order is ready or fulfilled on their mobile device, which may be done without the user entering an email address or phone number. Instead, the user may be provided the notification via data exchanges using short-range wireless communications. A message may be generated having a webpage address or another identifier allowing for retrieval of a webpage or user interface data for a notification that may include an order status. The order status may be updated in the notification, which may be provided on a user's mobile device.

### TECHNICAL FIELD

The present application generally relates to anonymity-enabled data transmission and more particularly to providing notifications and other alerts without requiring users to provide identifiers and identification information.

### BACKGROUND

Users may utilize online transaction processors for processing payments between different entities through device applications and digital accounts. Further, these online transaction processors may also provide payment options for in-person transaction processing and use at merchant locations. In this regard, merchants may utilize in-person payment terminals, such as point-of-sale (POS) devices that may include components and modules for local wireless exchanges of data and transaction processing. Merchants may implement payment services and processing functionalities from transaction processors through these POS devices and/or other payment terminals. Users may then pay utilizing payment instruments and/or funds, such as cash, credit or debit cards, mobile applications and digital wallets, and the like. Some purchases may require preparation and/or fulfillment by merchants, such as food orders at restaurants and/or service orders that require merchant attention and/or interaction. Conventionally, merchants may provide a queue, line, and/or order numbering system where users wait their turn and/or for their number or other identifier to be called or otherwise have the user notified that their order and/or turn is now available. Merchants have recently begun to use pager type devices, such as short-range and/or location-specific (e.g., local devices on a local network) to send alerts to users. However, these processes are cumbersome, require either provision of a number, queue place or order, and/or physical device to the user, and are only available locally within a confined area of the merchant.

Other processes to provide alerts to a user require the user to enter a contact identifier or other user and/or contact information, such as an email address or phone number for text messages. This reveals personal and private information to the merchant and/or other services providers engaged in this process, which may not be desirable for a user that wishes to protect their privacy. Due to unwanted communications and advertisements, dissemination of personal data, cyber-attacks, phishing schemes, and malware that may compromise the user's account, merchants or other service providers may desire to enforce further privacy protections, which may be required by law, regulations, and/or company policies. Thus, it is desirable for merchants to digitally notify users in a more convenient and efficient manner, with a larger range than physical queues and/or local devices, and without requiring users to utilize input contact identifiers or provide personal information (e.g., personally identifiable information (PII) including phone numbers, email addresses, etc.).

### BRIEF DESCRIPTION OF THE DRAWINGS

FIG. 1 is a block diagram of a networked system suitable for implementing the processes described herein, according to an embodiment;

FIG. 2 is an exemplary system environment where a mobile device interacts with a payment terminal device or system to facilitate receipt of pager data by the mobile device using short-range wireless communications for pager notifications to be received on the mobile device, according to an embodiment;

FIGS. 3A-3D are exemplary diagrams of payment terminals and mobile devices with corresponding user interface interacting to provide pager notifications on the mobile devices, according to an embodiment;

FIG. 4 is a flowchart of an exemplary process for short-range transmission of receipt data without contact identifiers, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for short-range transmission of receipt data without contact identifiers. Systems suitable for practicing methods of the present disclosure are also provided.

A user may utilize a digital account, payment card, and/or other funding source to process payments through an electronic payment and/or transaction network associated with a backend payment processor or other entity on the network. An identifier may be linked to a digital account of the user with an online transaction processor, such as a payment service provider (e.g., PAYPAL®) which may provide electronic transaction processing services to users through the account and one or more, real-world physical locations, websites, and/or applications of the online transaction processor or a merchant. The online transaction processor may include an integration with the electronic payment network (e.g., for payment cards, tokens, and the like) that allows for data exchange and communications between the two networks, such as to process transactions (e.g., approve or decline, and well as request monetary payments, transfers, conversions, etc.) and issue receipts or other transaction histories. Further, this payment network may provide data communications and backend processing devices that provide for interaction with frontend merchant, POS, and/or payment terminal processing devices that process transactions.

In some embodiments, frontend merchant devices may include POS devices and/or payment terminals processing payments using cash, check, and/or payment cards through near field communications (NFC), radio frequency identification (RFID) fields and communications, Bluetooth or WiFi communications, infrared scanners and/or communications, EMV chip readers, magnetic stripes and/or emulation readers, and other in-person and/or local data transfers. However, conventionally to utilize such payment mechanisms, users must share contact identifiers and/or other personal data so that the POS devices and/or payment terminals may communicate back with the user's mobile device or other computing device. This may not be desirable by some users and/or in certain circumstances, such as when users may be concerned with sharing PII, receiving unwanted advertisement, or the like. Merchants may also not want to receive and store PII due to regulatory requirements and/or concerns for data breaches. Conventionally, during transaction processing that requires preparation, fulfillment, and/or pick-up/delivery of an item or service purchased, a user is provided an order number or other identifier and given instructions on how to wait, queue, or otherwise receive their item(s) or service(s). More recently, pagers, such as “beepers” or “pucks” (e.g., small devices that may provide audio, visual, and/or haptic alerts), have been used to alert users of transaction and/or order fulfillment, such as readiness or completion of an order. However, these methods are obtrusive, require users to remain local to a specific area, and utilize unnecessary devices and data communications.

While merchants may contact users directly on their mobile devices, this requires that a user enter their contact information (e.g., name, email address, phone number, etc.). For example, text messages and emails may be transmitted by SMS/MMS or sent via email. However, input of contact identifiers and other contact data reveals private or personal information for the user, or otherwise compromises the user's anonymity, such that the merchant or other service providers may send undesired content to the user. Many merchants may disguise such processes as enrolling in reward systems, which may be undesirable by certain users and may create unnecessary and unwanted accounts or user data. As such, both users and merchants may be concerned with privacy and privacy protection laws or regulations, big data mining and advertisements or other outreach, and the like.

Thus, an online transaction processor, as discussed herein, may provide operations that allow for faster and more convenient order notifications and paging for order fulfillments using contactless or nearby data exchanges that do not require exchange of user or contact identifiers. During checkout, a payment terminal device or other computing system may provide users with an option to “tap” to obtain a “page” or notification on the user's mobile, wearable, or other computing device, thereby turning the user's device to a pager. A tap may generally refer to an NFC or RFID “tap” or wireless data exchange that wirelessly communicates data over a short-range (e.g., 4-5 centimeters (cm) or less for NFC taps, which allows sharing of a small data payload between NFC devices and/or readers, however other distances are contemplated). A transaction may be processed and an order notification, number, and/or identifier may be generated based on the request for a pager notification to be transmitted in this manner, which causes creation of a digital file and association with a particular webpage and/or webpage address for order tracking and fulfillment notification. When requesting to broadcast the notification for order fulfillment and paging, such as to obtain the data on the user's device through the short-range wireless communications and tap, the user is not required to enter contact or personal data, such as a contact identifier. Thus, the paging, alerting, and/or notifying process may continue independent of the payment terminal device or system obtaining such data.

In this regard, a webpage address (e.g., a uniform resource locator (URL), uniform resource identifier (URI), or other file path and/or resource locator usable to identify data over a network) for the webpage including transaction tracking and fulfillment data may then be broadcasted using an NFC standard. This standard may be utilized for a message having message embedding that causes a browser application on a mobile device to open and execute the browser application and navigate to the webpage. The notification's file and/or data for tracking of order fulfillment may then be loaded to the webpage, downloaded, or otherwise accessed and obtained via the webpage and address, which may occur without the user entering contact identifiers or other user contact information. Further, by utilizing short-range wireless communications (e.g., NFC communications limited to 4-5 cm of distance), sharing or theft of the order number, receipt, and other device may be minimized as any device being placed in such a proximity during data transmission would be able to be seen by the merchant, user, or another.

In a typical scenario, a user may desire to purchase items via available funds, a payment card, and/or a software application with a digital account at a real-world physical merchant location, such as a merchant storefront, retail location, or the like that provides in-person transaction processing through POS devices, payment terminals, and other merchant devices and systems. Selection of one or more items in an in-person transaction at a physical merchant location may require a payment instrument from the user for electronic transaction processing, which may be provided through a cash or other physical fiat currency, a payment card and embedded or encoded data (e.g., magnetic stripe, EMV chip, NFC chip, etc.), token, identifier, data package, or the like that is transmitted to a merchant device at the location. Payment may be made via short-range wireless communications (e.g., contactless payments via NFC, RFID, etc.) using a digital wallet with an online service provider or other transaction processor. A digital account with a service provider may be established by providing account details, such as a login, password (or other authentication credential, such as a biometric fingerprint, retinal scan, etc.), and other account creation details. The account creation details may include identification information to establish the account, such as personal information for a user, business or merchant information for an entity, or other types of identification information including a name, address, and/or other information.

The user may also be required to provide financial information, including digital account (e.g., credit/debit card) information, bank account information, gift card information, benefits/incentives, and/or financial investments, when processing transactions with merchants and/or other users or entities. Account creation may also be used to establish account funds and/or values, such as by transferring money into the account and/or establishing a credit limit and corresponding credit value that is available to the account and/or card. The service provider may provide computing services to send, store, and receive money, process financial instruments, and/or provide transaction histories. The service provider may also provide for tokenization of data for transaction processing. The application or website of the service provider, such as PayPal® or other online payment provider, may provide payments and the other transaction processing services. Moreover, the digital account may be utilized through one or more mobile applications for mobile devices or other software applications.

In order to pay for the transaction using the account (e.g., a transfer or payment to another user, merchant, or other entity), the user may provide the digital account or funding source information and/or may login to an account with the service provider through authentication information in a software application. When providing in-person payments through payment terminals and a mobile device, a digital wallet may be utilized with the account to provide data to the terminal or device wirelessly. In this regard, an identifier and/or digital token or other data may authorize and/or authenticate the user for their digital wallet use and/or a payment instrument in the digital wallet (e.g., the account with the online transaction processor), which may be transmitted to another party for payment processing via wireless communications. This token, identifier, or other payment data may be anonymized, limited use, and/or include obscured or hidden payment or financial data, PII, or the like, which may prevent revealing a user's identity and/or information. The data for transaction and payment processing may be stored by and/or transferred using one or more storage mediums and/or wireless transceivers, such as an NFC/RFID component, fob, passive or active antenna, etc., a magnetic stripe or an EMV chip, a displayable code or data, or the like. A payment may then be issued to the other party to the transaction. Thereafter, a receipt or other transaction history may be optionally provided, or required to be offered/provided, to the user to document and record the transaction processing (including approval and payment or refusal and reason for refusal).

After payment processing, a POS or payment terminal device of a merchant, or other merchant system and/or component, may prompt the user to determine whether the user would like a receipt and, if applicable to the transaction, an order identifier. When an order identifier is provided, the merchant's POS or payment terminal device may also provide a “tap to pager” option or other similar option that allows the user to receive notifications from the merchant for the particular transaction, whereby the user's device may be turned into a pager device for purposes of providing order notifications, statuses, and/or alerts when fulfilled, completed, or prepared. The user may select between options and/or have a preselection made (e.g., by the user, such as based on the user's past history, used payment instrument, loyalty account and/or preferences, or by the merchant). If the user selects the pager option for the user's device, such as the tap option for wireless NFC, RFID, or other short-range wireless protocol transmission, the payment terminal may then initiate a process to wirelessly broadcast and/or transmit data necessary to receive a pager notification of transaction statuses and/or updates for fulfillment via short-range wireless communications. Further, the device or system may not ask, request, or require user contact information and/or identifiers when communicating with the merchant's device wirelessly at the merchant location and within a proximity range between the user's mobile device and the merchant's POS device, payment terminal, or other merchant system. Thus, the process may proceed independently from requesting and receiving such personal and/or contact data.

A display device, component, or other output component may begin displaying instructions to wireless connect and/or communicate with the merchant's device to receive a page or other notification on the user's device, such as an instruction to “tap” the user's mobile or wearable device (e.g., mobile smart phone, smart watch, etc.) to a particular component or area of the POS device, payment terminal, or the like. The “tap” area may be indicated by the display device and/or by markings or configuration of the merchant's device and/or checkout infrastructure, and may include the short-range wireless transmitter, antenna, or transceiver, which may provide for broadcasting of data wirelessly to nearby devices. The payment terminal may also display an indicator, message, or other information that indicates when and for how long the data is being broadcast, such as a “Tap Now!” or “Sending!” message to indicate the broadcasting is occurring.

In order to perform the broadcast of data that may send and/or populate the webpage or application interface for the pager notification and order status(es) and/or update(s) on the user's device, the payment provider, transaction processor, or other service provider may create data for a webpage or other pathway that hosts and/or provides a notification and/or notification data that may track an order, such as by being updated when changes to the order's status is received from the merchant's device or backend system. The created data for the notification may correspond to a webpage address, a file path, and/or a data file, such as an extensible markup language (XML) or hypertext markup language (HTML) file or object that may be loaded by a webpage in a web browser application or in a software application interface (e.g., interface of a mobile application on a mobile device) in response to receiving the data, a navigation to, and/or opening of a webpage address, link, or data file. In this regard, a transaction processor and/or online webpage indexing and hosting systems may be utilized to generate the corresponding file and/or webpage.

The webpage or file may include information for the transaction and pending for preparation and/or fulfillment in the order, such as items or services, merchant location and/or merchant information, prices and costs, date and time, tax or other fees, tip or other additional gratuities and expenses, and the like. Further, a dynamic and/or updateable field, webpage/interface element, or other data on the webpage or in the interface may include the order's current status (e.g., pending, ready, fulfilled, please pick up, order arrival or delivery time/window, etc.). This dynamic and/or updateable field may be updated and changed as the merchant's device communicates with the service provider's backend to track, monitor, and/or update order status and provide such information to the user by allowing the user's device to access the webpage and/or application interface data that includes the current status information. The data file and/or webpage may then be stored, cataloged, and/or persisted to make available via the corresponding address, link, file path, or the like. The service provider's backend may be used as a centralized system and/or repository that allows for sharing of the order status and pager notifications with the user's mobile device.

To share the data with the user's mobile device, different communication pathways and channels may be utilized. For example, in a first scenario that does not require the user's mobile device or the like to share data back with the merchant's POS, payment terminal, or other device/system, the service provider may generate a message or other data for broadcast via the short-range wireless communications utilized by the POS or payment terminal device, or another merchant system/component. The message may be generated to include the webpage address in the message or other link, address, file path, or the like for webpages and/or application data (e.g., for display via application interfaces). In this regard, the message may have a field, portion, or the like that includes the webpage address, link, or patch, such as having the address embedded in a message header, body, etc. The message may automatically cause a computing device receiving the message to open or execute a web browser application or dedicated software application and navigate to the webpage or populate an interface notification or element notifying the user of the webpage and whether the user would like to load the webpage in the browser application. The message may also cause other applications to open and/or load the webpage or data accessible at the link or file path in one or more interfaces. Such opening and/or loading may be done automatically or after accepting an interface prompt and request based on the computing device receiving the message. For example, a mobile device may be configured with NFC protocols and operations to receive NFC messages having web addresses embedded in a particular portion, which causes the mobile device to load and navigate to such address in a web browser application. This would then cause the webpage file to be loaded for the pager notifications such that the user's device may receive pager notifications via updates to the webpage and/or application data. If a failure to exchange data occurs, the merchant and/or user may select an option for other transmission of the data via a displayable code on a display component of the merchant's device, such as a Quick Response (QR) code, which may be captured by the user's device using a camera, code scanner, or the like.

In a second scenario, when paying for the transaction, the user's mobile device may provide a payment via a digital wallet and stored payment instrument, accessible value, cryptocurrency, and/or token. The user's mobile device may be used for a “tap-to-pay” type feature where a payment may be made through NFC data exchange. Further, the user's digital wallet may authorize or the user may consent to the wallet sharing a loyalty identifier or other information that may be used by the service provider to identify the user and therefore the user's device. The service provider, after generating the webpage and/or application interface data, as described above, may then share, push, transmit, or otherwise provide the data to the user's device directly over a network connection, such as a cellular data network. This may occur without relaying the data through the merchant's device, which therefore does not require the user's device to be tapped again to the merchant's device. Further, the loyalty data may be tokenized, encrypted, or otherwise secured from being revealed (e.g., in plaintext) to the merchant's device for additional privacy or security. As such, the service provider's backend and user's device may communicate to exchange pager notifications and status updates via the webpage or application interface data. Other scenarios may also be used for exchange of an identifier to have the service provider's backend push or provide data to the user's device, as well as processes to share data without identifier exchange between the user's device and the merchant device (e.g., WiFi, Bluetooth, etc.).

When the user's mobile device receives the message, the notification that includes the status of the order and pager alerts or data may be loaded and may be made available as a webpage page in the browser application or application interface. After the user's mobile or other computing device receives the data, the user may perform additional actions with the data, such as by refreshing, waiting for automatic refreshes or data loads, and the like, which may update and change the status of the order for completion and notification of pickup, delivery, or other availability. In this manner, pager notifications and alerts on users' mobile devices may be made anonymous and without requiring users to enter contact and/or personal data, thereby increasing online and digital user privacy protection. This allows merchant systems to be more regulatory compliant and provide customer-focused processes for privacy protection. Further, the operations provide faster and more efficient alerting of users for order statuses without requiring another computing infrastructure and use of single or limited-use devices for specific paging purposes, which may be costly, wasteful, and of limited range or proximity. Therefore, a merchant system for notifying users or order statuses may be coordinated in such a manner to provide data in faster, more secure, and more efficient notifications, which improves merchant ordering and data transmission systems.

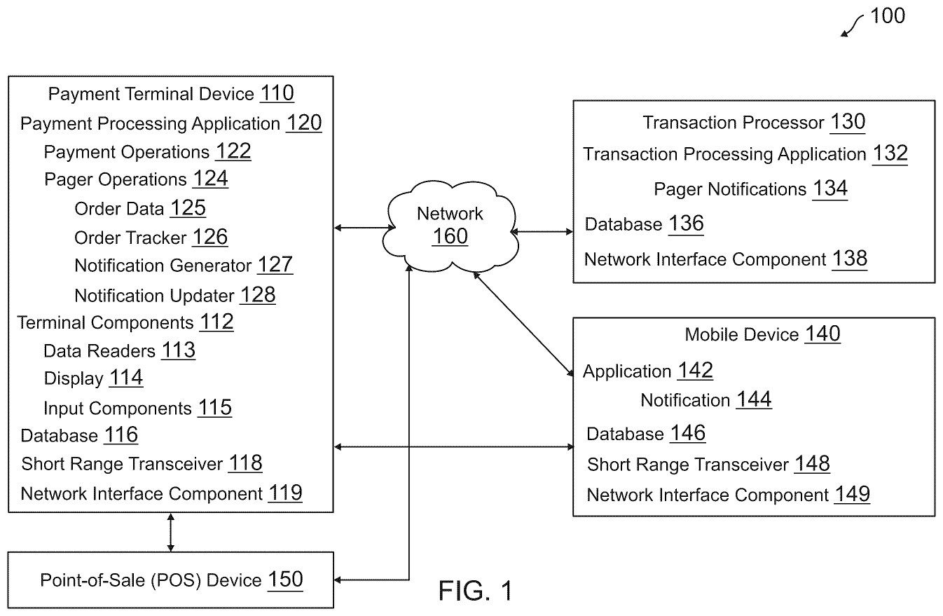

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a payment terminal device 110, a transaction processor 130, a mobile device 140, and a POS device 150 in communication over a network 160. Payment terminal device 110 and/or mobile device 140 may be used to establish a transaction and process a payment for the transaction. In this regard, when the transaction is processed, the transaction data may be processed, such as between payment terminal device 110 and transaction processor 130. Payment terminal device 110 may then provide an option to page or otherwise provide notifications to mobile device 140, such as by transmission of data over short-range wireless communications to and/or from mobile device 140 without requiring the user associated with mobile device 140 to enter or provide personal information and/or contact identifiers directly to payment terminal device 110 and/or POS device 150.

Payment terminal device 110, transaction processor 130, mobile device 140, and/or POS device 150 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

Payment terminal device 110 may be implemented using any appropriate hardware and software configured for wired and/or wireless communication with user devices, and may correspond to a single or all-in-one system for a merchant device, POS device and/or checkout register, or the like. However, in other embodiments, payment terminal device may correspond to a card reader, payment terminal, contactless payment transceiver and device, and the like that integrates locally and/or on the back end with POS device 150 or another merchant system used for processing a transaction. As such, in different embodiments, payment terminal device 110 and POS device 150 may correspond to the same device configured to provide payment processing using transaction processor 130 over network 160, or may correspond to separate devices that interact to provide such payment processing. In various embodiments, payment terminal device 110 may be implemented as a personal computer (PC), a payment terminal device with payment processing components, a smart phone, laptop/tablet computer, wristwatch with appropriate computer hardware resources, other type of wearable computing device, and/or other types of computing devices capable of transmitting and/or receiving data. Although only one device is shown, a plurality of devices may function similarly.

Payment terminal device 110 of FIG. 1 contains a payment processing application 120, terminal components 112, a database 116, a short-range transceiver 118, and a network interface component 119. Payment processing application 120 may correspond to executable processes, procedures, and/or applications with associated hardware. In other embodiments, payment terminal device 110 may include additional or different modules having specialized hardware and/or software as required.

Payment processing application 120 may correspond to one or more processes to execute software modules and associated components of payment terminal device 110 to provide features, services, and other operations for payment processing with a merchant POS device and/or over network 160 with transaction processor 130, which may include processes to provide pager notifications and other alerts or information for order fulfillment and completion on mobile device 140. In this regard, payment processing application 120 may correspond to specialized software utilized by a user of payment terminal device 110 that may be used to access a website or application (e.g., mobile application, rich Internet application, or resident software application) that may display one or more user interfaces that allow for interaction with the computing services of transaction processor 130 for payment processing. In various embodiments, payment processing application 120 may correspond to a general browser application configured to retrieve, present, and communicate information over the Internet (e.g., utilize resources on the World Wide Web) or a private network. For example, payment processing application 120 may provide a web browser, which may send and receive information over network 160, including retrieving website information, presenting the website information to the user, and/or communicating information to the website. However, in other embodiments, payment processing application 120 may include a dedicated application of transaction processor 130, a merchant system or merchant device, or other entity.

Payment processing application 120 may include payment operations 122, which may be used to process payments with users. For example, payment operations 122 may be used to receive and/or generate a transaction to purchase one or more items or services, such as by receiving item or service input and selection through item scanning, menu or interface selections and input, receipt of a transaction or order from another device or server (e.g., generated by mobile device 140 and provided to payment terminal device 110 for processing and/or fulfillment), and the like. Payment operations 122 may further request payment for the transaction, which may be provided using cash and merchant input, a check and merchant input and/or a check reader, a payment or gift card using a card reader (e.g., magnetic stripe reader, EMV or RFID chip reader, etc.), and/or a contactless payment terminal and component for mobile application payments from mobile devices (e.g., via NFC, RFID, QR code scanning, etc.). Payment processing application 120 may process a transaction and/or a payment request using payment data from one or more contactless payment devices, terminals, transceivers, or the like, as well as merchant input (e.g., cash or check transactions).

Payment operations 122 may allow a merchant and/or user to enter, receive, and process transaction and payment data. In this regard, payment operations 122 may utilize terminal components 112, short-range transceiver 118, and/or network interface component 119 for data entry and/or communication. Thereafter, payment processing application 120 may be used to view the results of transaction processing and the like via one or more interfaces, which may include a receipt or other transaction history that may be transmitted to mobile device 140 or another endpoint/address and/or printable on a physical receipt. This may include short-range wireless transmissions of digital receipts or other receipt data independent of requiring a user to provide input for an email address, phone number, or the like for receipt data transmission.

Pager or notification operations 124 may be used to provide notifications and/or other data to devices that allow such devices to access, retrieve, and/or output notifications to users, which may be associated with transaction and/or purchased order statuses as those orders are prepared, fulfilled, and/or completed. In this regard, pager operations 124 may include executable operations for or associated with order data 125, an order tracker 126, a notification generator 127, and a notification updater 128. Pager operations 124 may be invoked and executed on transaction completion (or other times during a transaction, including when an order is placed, while the order is being prepared, and/or when the order is ready for pickup) and may be used to generate and provide one or more notifications to a user that includes an order status for an order purchased in the transaction (e.g., one or more items and/or services requiring preparation, fulfillment, completion, or the like, where a user may have to wait for fulfillment and/or completion, queue in a line, or the like). For example, pager operations 124 may initially request that the user select whether to receive such notifications on mobile device 140. This may be done through a “tap-to-pager” option, which alerts the user that notifications are available to be received on mobile device 140.

If the option is selected to receive a pager notification for an order and the order's status on mobile device 140, data may be exchanged via an NFC or similar tap, or short-range wireless communications within a proximity range (e.g., bringing mobile device 140 within 4-5 cm of payment terminal device 110 and/or short-range transceiver 118 of payment terminal device 110 for NFC transmissions). Order data 125 may be generated, such as an identifier (e.g., alphanumeric code, such as a number), which may uniquely identify the order from other pending orders. Order tracker 126 may be implemented with an item preparation, fulfillment, completion, or other system to track a status of the order, which may receive updates to the order automatically by other preparation components and/or from user inputs. With order data 125 and order tracker 126, a webpage and/or data for an application interface may be generated by notification generator 127, such as by transaction processor 130 and/or another backend of transaction processor 130 or other service provider. The data for the notification may correspond to a file, document, or data object that includes order data 125 and/or a dynamic field or updateable portion for a status and status updates provided by order tracker 126. For example, an XML or HTML file may be generated by notification generator 127 and updated using notification updater 128, where the file may be associated with a network pathway and address (e.g., a webpage address for a webpage that loads data) accessible via a corresponding webpage address, link, loading event, file path, or the like for retrieval of the webpage and/or application interface data. The webpage address may navigate to the webpage that causes loading of the file from the corresponding pathway, such as an online or cloud storage system.

As such, notification generator 127 may generate a digital message or communication that may be broadcast via the short-range wireless communications to a device within a range or proximity of payment terminal device 110, such as mobile device 140 when mobile device 140 is tapped or placed within a certain range for NFC or similar transmissions. Notification generator 127 may generate a message using a messaging protocol for the short-range wireless communications and protocol, such as an NFC transmittable message. The webpage address, file path, or other link, URI or URL, or the like may be added, embedded, or otherwise provided with the message so that the message may cause mobile device 140 to prompt for or automatically navigate to the webpage using the webpage address or load application data for an application interface, which causes loading, display, and/or output of order data 125 with an order status tracked, updated, and/or maintained by order tracker 126.

Once generated, terminal components 112 and/or short-range transceiver 118 may be used to broadcast the message over short-range wireless communications. For example, payment terminal device 110 may utilize short-range transceiver 118 to transmit the message using a short-range wireless messaging protocol and technology. While short-range wireless communications, transmission, and protocols described herein may often refer to NFC, which may be used to transmit data between devices in close proximity or short range (e.g., 4-5 cm), other wireless technologies may also be used (e.g., RFID, Bluetooth, WiFi, etc.). The message may be broadcasted for a set amount of time, until received, and/or until a stoppage of broadcasting is requested. The message may be broadcast continuously or periodically and may be limited to a certain distance or proximity when transmitting.

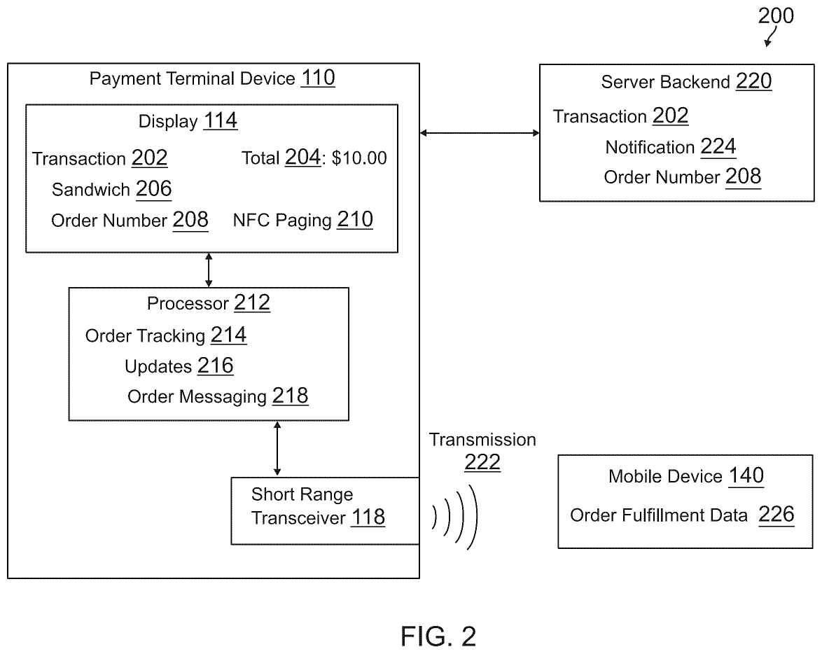

Pager operations 124 to generate and transmit notifications for order statuses may be performed in this wireless manner without utilizing contact identifiers and other personal data of users. If data transmission is unsuccessful, pager operations 124 may transmit the data through another means. For example, data may be embedded or encoded in a displayable code, such as a QR code, for display and scanning or capture by mobile device 140 to process and receive the notifications. After transmission, notification updater 128 may then maintain updates to the order status based on new data from order tracker 126, which may update the webpage or interface field and/or data based on changes to the status of the order received and/or tracked by order tracker 126. Examples of such pager notification operations via short-range wireless communications without contact identifiers are further discussed with regard FIGS. 2A-4 below.

In various embodiments, payment terminal device 110 includes other applications as may be desired in particular embodiments to provide features to payment terminal device 110. For example, the other applications may include security applications for implementing client-side security features, programmatic client applications for interfacing with appropriate application programming interfaces (APIs) over network 160, or other types of applications. In various embodiments, the other applications may include financial applications, such as banking applications and the like for payment processing. The other applications may include device interface applications and other display modules that may receive input from the user and/or output information to the user. For example, the other applications may contain software programs, executable by a processor, including a graphical user interface (GUI) configured to provide an interface to the user. The other applications may use terminal components 112 of payment terminal device 110, such as a display 114 capable of displaying information to users and other output devices, including speakers.

Terminal components 112 of payment terminal device 110 may be used to provide additional functionality and assist in transaction and payment processing. In this regard, terminal components 112 may include data readers 113, which may be configured to read data from payment cards, gift cards, mobile devices, key fobs, and the like. The data read from such devices may include payment data, and therefore data readers 113 may include magnetic stripe readers, EMV chip readers, NFC card of fob device readers, and the like. Terminal components 112 further include display 114, which may be configured to output and display data to the user and/or merchant. Display 114 may be used during transaction processing to display transaction processing input, results, and the like. This may include prompts for payment data input, receipt conveyance channel selection, and the like. While broadcasting a message for a digital receipt via short-range wireless communications, display 114 may also be used to display when the message is being broadcast, if message transmission is successful or receipt acknowledged, and/or a remaining time or end of broadcast. Ending the broadcast may cause display 114 to provide a prompt to rebroadcast or transmit via another process, such as a QR code. In this regard, terminal components 112 further include input components 115, such as buttons, a keyboard, a mouse, a touch screen interface, and the like, which enable the aforementioned inputs and selections to be made.

Payment terminal device 110 may further include database 116 stored on a transitory and/or non-transitory memory of payment terminal device 110, which may store various applications and data and be utilized during execution of various modules of payment terminal device 110. Database 116 may include, for example, identifiers such as operating system registry entries, cookies associated with payment processing application 120 and/or the other applications, identifiers associated with hardware of payment terminal device 110, or other appropriate identifiers, such as identifiers used for payment/user/device authentication or identification, which may be communicated as identifying the merchant and/or payment terminal device 110 to transaction processor 130. Moreover, database 116 may include data for digital receipts, orders and order tracking, and the like, which may include order data 125 and/or order statuses tracked and updated by order tracker 126 and notification updated 128, respectively.

Payment terminal device 110 includes at least one short-range transceiver 118 adapted to communicate with mobile device 140, POS device 150, and/or other nearby devices, transceivers, and/or components through short-range wireless signaling and communications including NFC communications, RFID communications, Bluetooth, WiFi, infrared scanners and/or communicators, and the like. In various embodiments, short-range transceiver 118 may correspond to microwave, RF, infrared, Bluetooth, and NFC devices and components.

Payment terminal device 110 includes at least one network interface component 119 adapted to communicate with transaction processor 130, POS device 150, and/or other devices and servers over network 160. In various embodiments, network interface component 119 may include a WiFi component, a DSL (e.g., Digital Subscriber Line) modem, a PSTN (Public Switched Telephone Network) modem, an Ethernet device, a broadband device, a satellite device and/or various other types of wired and/or wireless network communication devices.

Transaction processor 130 may be maintained, for example, by an online service provider, which may provide processes to provide account services and process payments. In this regard, transaction processor 130 includes one or more processing applications which may be configured to interact with payment terminal device 110, mobile device 140, POS device 150 and/or another device/server to facilitate communications for transactions, payment processing, and receipt provision for merchants and users. Transaction processor 130 may be maintained by or include another type of platform or service provider, for example, a transaction processor such as PAYPAL®, Inc. of San Jose, CA, USA.

Transaction processor 130 of FIG. 1 includes a transaction processing application 132, a database 136, and a network interface component 138. Transaction processing application 132 may correspond to executable processes, procedures, and/or applications with associated hardware. In other embodiments, transaction processor 130 may include additional or different modules having specialized hardware and/or software as required.

Transaction processing application 132 may correspond to one or more processes to execute modules and associated specialized hardware of transaction processor 130 to process a transaction for item(s) with payment terminal device 110 and/or mobile device 140, which may be based on in-person, short-range wireless, and/or contactless payments, data transfers, communications, and the like. In this regard, transaction processing application 132 may correspond to specialized hardware and/or software used by users to establish accounts and/or engage with electronic transaction processing services. Accounts may each be created by providing personal and/or financial information to transaction processor 130 and selecting authentication credentials. In various embodiments, the financial information may include payment instrument information, such as account/card numbers and information. An account may be used to purchase items and/or transfer funds. The payment account may be accessed and/or used through a browser application and/or dedicated payment application. Transaction processing application 132 may process a payment and may provide a transaction history for transaction authorization, approval, or denial.

Transaction processing application 132 may correspond to a service of transaction processor 130 that may be utilized by end users, such as to perform electronic payments, transfers, and the like using one or more accounts and/or financial instruments. Transaction processing application 132 may also include or utilize different processors, engines, or models as required for an authentication, account setup and maintenance, electronic transaction processing, deposit and/or withdrawal, dispute resolution, and the like. Transaction processing application 132 may include one or more API integrations and/or interactions with payment terminal device 110 and/or payment networks in order to detect, receive, and monitor order data 125 including order statuses updated by order tracker 126 in order to facilitate providing pager notifications 124 on mobile device 140. For example, pager notifications 134 may correspond to XML/HTML files or other data for webpages and the like where notifications may be hosted for orders and order statuses, including providing order data 125 with a status tracker updated by order tracker 126 in a webpage field, area, element, or the like. Pager notifications 134 may also correspond to application data displayable by one or more user interfaces, such as the data necessary to display an application interface having a notification regarding an order status on mobile device 140. As such, pager notifications 134 may be generated by transaction processing application 132 and provided to payment terminal device 110 and/or mobile device 140 for a user to receive notifications of an order status (e.g., pending, ready, fulfilled, completed, etc.) on mobile device 140, as discussed herein.

Transaction processing application 132 may correspond to one or more processes to execute modules and associated specialized hardware of transaction processor 130 to process a transaction or provide another service to customers, merchants, and/or other end users and entities of transaction processor 130. In this regard, transaction processing application 132 may provide computing services to users, which may include electronic transaction processing and/or other computing services using accounts provided by transaction processor 130, such as in response to receiving transaction data for electronic transaction processing of transactions. In some embodiments, transaction processing application 132 may be used by users, such as a user associated with mobile device 140, to establish user and/or payment accounts, as well as digital wallets, which may be used to process transactions. Accounts may be accessed and/or used through one or more instances of a web browser application and/or dedicated software application executed by mobile device 140 and engage in computing services provided by transaction processing application 132. Computing services of transaction processing application 132 may also or instead correspond to messaging, social networking, media posting or sharing, microblogging, data browsing and searching, online shopping, and other services available through transaction processor 130.

In various embodiments, transaction processing application 132 may be desired in particular embodiments to provide features to transaction processor 130. For example, transaction processing application 132 may include security applications for implementing server-side security features, programmatic client applications for interfacing with appropriate application programming interfaces (APIs) over network 160, or other types of applications. Transaction processing application 132 may contain software programs, executable by a processor, including a graphical user interface (GUI), configured to provide an interface to the user when accessing transaction processor 130 via one or more of payment terminal device 110 and/or mobile device 140, where the user or other users may interact with the GUI to view and communicate information more easily. In various embodiments, transaction processing application 132 may include additional connection and/or communication applications, which may be utilized to communicate information to over network 160.

Additionally, transaction processor 130 includes and/or is able to access database 136. Database 136 may store various identifiers associated with mobile device 140. Database 136 may also store account data, including payment instruments and authentication credentials, as well as transaction processing histories and data for processed transactions. Database 136 may store received data associated with a user, such as transaction data and spending limits on electronic transaction processing. Further, database 136 may be used to store data for pager notifications 134, transactions, orders, and the like. Although database 136 is shown as residing on transaction processor 130 as a database, in other embodiments, other types of data storage and components may be used including cloud computing storage nodes, remote data stores and database systems, distributed database systems over network 160 and/or of a computing system associated with transaction processor 130, and the like.

In various embodiments, transaction processor 130 includes at least one network interface component 138 adapted to communicate with payment terminal device 110, mobile device 140, POS device 150, and/or another device/server over network 160. In various embodiments, network interface component 138 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Mobile device 140 may be implemented using any appropriate hardware and software configured for wired and/or wireless communication with merchant devices, payment terminals, contactless payment transceivers and devices, and/or transaction processor 130 for processing a transaction and receiving a digital receipt independent or without of providing or inputting data that may be used to contact a user or other personal data of the user. Mobile device 140 may correspond to a user that processes payments and sales through an executable software application. In various embodiments, mobile device 140 may be implemented as a personal computer (PC), a smart phone, laptop/tablet computer, wristwatch with appropriate computer hardware resources, other type of wearable computing device, and/or other types of computing devices capable of transmitting and/or receiving data. Although only one mobile/user device is shown, a plurality of mobile/user devices may function similarly.

Mobile device 140 of FIG. 1 contains an application 142, a database 146, a short-range transceiver 148, and a network interface component 149. Application 142 may correspond to executable processes, procedures, and/or applications with associated hardware. In other embodiments, mobile device 140 may include additional or different modules having specialized hardware and/or software as required.

Application 142 may correspond to one or more processes to execute software modules and associated components of mobile device 140 to provide features, services, and other operations for a user over network 160, which may include accessing and utilizing computing services provided by transaction processor 130. In this regard, application 142 may correspond to specialized software utilized by a user of mobile device 140 that may be used to access a website or application (e.g., mobile application, rich Internet application, or resident software application) that may display one or more user interfaces that allow for interaction with the computing services of transaction processor 130. In various embodiments, application 142 may correspond to a general browser application configured to retrieve, present, and communicate information over the Internet (e.g., utilize resources on the World Wide Web) or a private network. For example, application 142 may provide a web browser, which may send and receive information over network 160, including retrieving website information, presenting the website information to the user, and/or communicating information to the website. In this regard, application 142 may be activated, opened, and/or executed in response to a message from payment terminal device 110, which may cause loading of notification 144 based on embedded or encoded data, such as a webpage address with a corresponding message protocol to prompt for navigation to or automatically navigate to notification 144. However, in other embodiments, application 142 may instead correspond to a dedicated or mobile software application of transaction processor 130, a merchant, or another entity, which may allow for opening and/or navigating to webpages, interfaces, and the like to display and output notification 144 based on data for an application interface.

Application 142 may be associated with account information, user financial information, and/or transaction histories including notification 144. However, in further embodiments, different services may also be provided via application 142, including social networking, media posting or sharing, microblogging, data browsing and searching, online shopping, and other services available through transaction processor 130. Thus, application 142 may also correspond to different service applications and the like. When utilizing application 142 with transaction processor 130, application 142 may request processing of a transaction, such as a payment request with transaction processor 130. Thereafter, a token or other data may be transmitted wirelessly, such as through short-range wireless communications for contactless or short-range payment protocols, devices, and technology.

In some embodiments, this token may include loyalty information or other applicable user, account, or identification information, which may be tokenized and/or encrypted to prevent user information from being revealed if intercepted (e.g., read in clear or plain text). Such data may allow for direct communications by transaction processor 130 with mobile device 140 to provide and load notification 144 in application 142 after generation of order data 125 and a corresponding pager website or application interface data for a pager notification. However, in other embodiments, the payment information does not include such data and the data for notification 144 may be sent to mobile device 140 for population in application 142 from payment terminal device 110. Application 142 may be used to view the results of transaction processing and the like via one or more interfaces, such as notification 144 in response to receiving a broadcast of the correspond message for the digital receipt by payment terminal device 110.

In various embodiments, mobile device 140 includes other applications as may be desired in particular embodiments to provide features to mobile device 140. For example, the other applications may include security applications for implementing client-side security features, programmatic client applications for interfacing with appropriate application programming interfaces (APIs) over network 160, or other types of applications. The other applications may also include email, texting, voice and IM applications that allow a user to send and receive emails, calls, texts, and other notifications through network 160. In various embodiments, the other applications may include financial applications, such as banking applications. Other applications may include social networking applications, media viewing, and/or merchant applications.

The other applications may also include location detection applications, which may be used to determine a location for the user, such as a mapping, compass, and/or GPS application, which can include a specialized GPS receiver that determines location information for mobile device 140. The other applications may include device interface applications and other display modules that may receive input from the user and/or output information to the user. For example, the other applications may contain software programs, executable by a processor, including a graphical user interface (GUI) configured to provide an interface to the user. The other applications may use components of mobile device 140, such as display devices capable of displaying information to users and other output devices, including speakers.

Mobile device 140 may further include or be associated with database 146, which may store various applications and data and be utilized during execution of various modules of mobile device 140. Database 146 may correspond to different types of data storage and components including cloud computing storage nodes, remote data stores and database systems, distributed database systems over network 160, and the like used to store various applications and data. Database 146 may include, for example, identifiers such as operating system registry entries, cookies associated with application 142 and/or other applications, identifiers associated with hardware of mobile device 140, or other appropriate identifiers, such as identifiers used for user/device authentication or identification, which may be communicated as identifying the user and/or mobile device 140 to transaction processor 130.

Mobile device 140 includes at least one short-range transceiver 148 adapted to communicate with payment terminal device 110 and/or other nearby devices, transceivers, and/or components through short-range wireless signaling and communications including NFC communications, RFID communications, Bluetooth, WiFi, infrared scanners and/or communicators, and the like. In various embodiments, short-range transceiver 148 may correspond to microwave, RF, infrared, Bluetooth, and NFC devices and components.

Mobile device 140 includes at least one network interface component 149 adapted to communicate with transaction processor 130 and/or other devices and servers over network 160. In various embodiments, network interface component 149 may include a WiFi component, a DSL (e.g., Digital Subscriber Line) modem, a PSTN (Public Switched Telephone Network) modem, an Ethernet device, a broadband device, a satellite device and/or various other types of wired and/or wireless network communication devices.

POS device 150 may be implemented as a communication device that may utilize appropriate hardware and software configured for wired and/or wireless communication with payment terminal device 110, transaction processor 130, and/or other devices and servers including merchant purchasing, fulfillment, and/or checkout systems and components. For example, in one embodiment, POS device 150 may be implemented as a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data. Although only one device is shown, a plurality of devices may function similarly and/or be connected to provide the functionalities described herein.

POS device 150 may include one or more applications and/or to provide sales and transaction processing features, services, and other operations by a merchant for consumers, which may include merchant sales operations, POS device processing and/or operations, online merchant marketplaces, sales and inventory services, and the like. POS device 150 may engage with transaction processor 130 for use of a merchant account, payment and/or electronic transaction processing services, and other computing services provided. In some embodiments, this may further include processes for merchant sales, inventory, return or exchange, risk analysis, and other services a merchant may require during the course of their business and sales. In this regard, POS device 150 may correspond to specialized software utilized by a merchant or other user of POS device 150 that may provide applications and application data based on the account and/or computing services provided by transaction processor 130. POS device 150 may provide and/or process items for sale with payment terminal device 110, mobile device 140, and/or a user interacting with POS device 150 (e.g., using a POS device, the website, mobile application, or another merchant marketplace platform). In certain examples, POS device 150 may be accessible over the Internet and provide for sales with POS device 150 over network 160.

In some embodiments, POS device 150 may correspond to and/or be used to configure a checkout application at a physical merchant location, such as the application(s) of a point-of-sale (POS) device used to provide sales at physical locations. For example, POS device 150 may be used to establish a transaction once a user/employee associated with POS device 150 has selected one or more items for purchase and/or entered the item(s) to the transaction for processing. Once a payment amount is determined for the item(s) to be purchased by the user, POS device 150 may request payment for the transaction. Payment may be provided using electronic transaction processing services enabled and/or provided by transaction processor 130 via payment terminal device 110, as discussed herein. In this regard, payment may be received from a user and may be processed using payment terminal device 110 and/or transaction processor 130, and POS device 150 may interact with payment terminal device 110 for payment processing and/or reading, receiving, and/or processing data. As such, payment terminal device 110 and POS device 150 may interact when performing the short-range wireless communication discussed herein to provide data to mobile device 140 without requiring and/or requesting identification information, contact identifiers, and the like. After receipt of payment and/or confirmation of the payment, POS device 150 may then process a payment to the merchant associated with POS device 150.

Although payment terminal device 110 and POS device 150 are shown as separate devices interacting, such as a payment terminal and/or card reader with a merchant POS device, it is understood that payment terminal device 110 and POS device 150 may be the same device and/or system or one or more components or operations of payment terminal device 110 and POS device 150 may be provided by the same device or system.

Network 160 may be implemented as a single network or a combination of multiple networks. For example, in various embodiments, network 160 may include the Internet or one or more intranets, landline networks, wireless networks, and/or other appropriate types of networks. Thus, network 160 may correspond to small scale communication networks, such as a private or local area network, or a larger scale network, such as a wide area network or the Internet, accessible by the various components of system 100.

FIG. 2 is an exemplary system environment 200 where a mobile device interacts with a payment terminal device or system to facilitate receipt of order data by the mobile device using short-range wireless communications for pager notifications to be received on the mobile device, according to an embodiment. System environment 200 of FIG. 2 includes payment terminal device 110 interacting with mobile device 140, discussed in reference to system 100 of FIG. 1, to facilitate transmission of data wirelessly and without requiring mobile device 140 and/or a corresponding user to enter an identifier or other user information. The data may be used for order tracking, such as to receive pager notification of order fulfillment and/or preparation status. In this regard, a server backend 220 (e.g., one or more servers and/or backend processors of transaction processor 130 discussed in reference to system 100) may provide notification generation and provision of webpage or interface data for notification output.

In system environment 200 of FIG. 2, different interactions, data, and components are shown in order to generate and transmit a pager notification or other data for an alert wirelessly to mobile device 140 from payment terminal device 110 over a short-range wireless communication channel/connection, or over a network to an address or account, without requiring a contact identifier or other user contact information to be directly input to payment terminal device 110. Initially, payment terminal device 110 may be used to create, generate, and/or input a transaction, which may correspond to a user utilizing mobile device 140. The transaction may be for purchase of items and/or services from a merchant and the merchant or an employee of the merchant may be utilizing payment terminal device 110 to finalize and process the transaction. As such, display 114 may present information for a transaction 202 having a transaction total 204 for an item 206, such as a sandwich or another good, product, service, or the like from a merchant. Item 206 may have been scanned (e.g., based on a barcode, packaging, etc.) or entered/selected for purchase, and transaction total 204 may then be generated. Thereafter, the user and/or mobile device 140 may provide a payment instrument to pay for and process transaction 202.

An order number 208 may be provided on display 114, where the merchant or the user may select an option to wirelessly page or alert the user of a status of the order based on order number 208. For example, data for a pager notification may be generated from a short-range wireless interaction between payment terminal device 110 and mobile device 140, such as a “tap to receive” option that does not require the user to enter their contact information and/or identifiers for data exchange. The process to exchange the data may be requested via a selectable option for NFC paging 210, which allows for order number 208 and a corresponding pager notification to be generated and exchanged with mobile device 140. For example, communications between payment terminal device 110 and mobile device 140 may be performed via short-range wireless communications, which may be done by placing a corresponding device and/or transceiver (e.g., mobile device 140) within a wireless proximity range to payment terminal device 110 and short-range transceiver 118. This allows for NFC or other short-range wireless communications to exchange data, which may be used for payments, as well as to exchange data for pager notifications on mobile device 140 when NFC paging 210 is selected and/or requests. For example, NFC data exchange format (NDEF) may be utilized, which may correspond to a standardized data format specification used for NFC data transmissions. NDEF may be used to encode actions to NFC tags and/or exchange data between devices, which allow generating, transmitting, and/or reading NDEF messages by and between devices.

A processor 212 of payment terminal device 110 may generate an order tracking 214 for transaction 202, which may correspond to order number 208 and an identifier, transaction data, or the like used in an order tracking and/or fulfillment system that monitors the order status and alerts users, including customers and/or employees, of when an order is ready, completed, or available for pickup and/or retrieval. Processor 212 may correspond to a hardware and/or software processor that may be configured to process data for transaction 202 and order tracking 214, such as using operations of payment processing application 120. An XML, HTML, or other data file may be loaded in a browser application, such as by navigation to a corresponding webpage using a webpage address. However, other applications and identifiers for online data retrieval may also be used, such as application interface data for a specific mobile software application of a merchant, transaction processor, or other service provider. Order tracking 214 may be associated with updates 216, which may include changes or updates to a status of the order for transaction 202, such as when item 206 may be prepared and ready, and may provide information for when item 206 is ready for order fulfillment. Processor 212 may generate order messaging 218 to transmit order tracking 214 by embedding, adding, or otherwise providing status and/or status updates in the message structure or content, such as in a message field, for updating of a webpage and/or in an application interface. In some embodiments, order messaging 218 may cause order tracking 214 to load from a webpage or in an application in a corresponding application on mobile device 140.

Order tracking 214 may correspond to data, identifiers, addresses, and the like for order data and status retrieval, which may be stored by processor 212 and provided to server backend 220 for pager notification generation. Server backend 220 may correspond to a server and data storage system that may generate a notification 224 for transaction 202 based on order number 208, which may include changes from order tracking 214 for updates 216. Server backend 220 may process transaction 202 to provide a payment, which may then initiate order tracking 214 and generation of notification 224 for order number 208. As such, server backend 220 may further correspond to an online transaction processor or other payment service that may electronically process transaction 202 and store order tracking 214 for transaction 202. Notification 224 may be generated as a webpage with corresponding webpage data in one or more webpage interfaces, fields, elements, menus, or the like for order number 208 and status changes of updates 216 from order tracking 214. Notification 224 may also or instead correspond to application data, such as data presentable via one or more application interfaces, As such, notification 224 may be presented on mobile device 140 to view a status of the order corresponding to transaction 202 that was processed, and may be updated, changed, refreshed, reloaded, or the like to change and update an order status based on order tracking 214.

To provide notification to mobile device 140, a link to a webpage, network resource, and/or address that may load notification 224 (e.g., a URL for a webpage or a URI/file path to online data for a webpage or application data) may be generated by server backend 220. This may be added, inserted, or used to generate a message, which may be transmitted to mobile device 140. Transmission may occur via payment terminal device 110, such as via short-range transceiver 118 through transmission 222, which may include order messaging 218 for order tracking 214 to mobile device 140. Transmission 222 may correspond to a direct data transmission or communication, as well as broadcasts of data that may not be device specific. Further, transmission 222 may cause order messaging 218 to be received by mobile device 140, which prompts mobile device 140 and/or the corresponding user to open order messaging 218, navigate to a webpage or application data using the link or other data in the message, and load notification 224 on mobile device 140. As such, order fulfillment data 226 may present a current order status and/or fulfillment information to a user based on notification 224. Further, such opening, navigating, and loading may be performed automatically on receipt of order messaging 218 from transmission 222 by mobile device 140.

If transmission 222 fails, display 114 may further be used to display and output a code, such as a barcode or QR code, having encoded data that includes order tracking 214, the link to the data, or other data for loading and providing order messaging 218 on mobile device 140. Such output may be responsive to a failure to transmit transmission 222, a failure of mobile device 140 to detect transmission 222 and/or a command input on payment terminal device 110 (e.g., a request to end transmission 222 and display the QR code, such as if there is an error or inability to exchange data). Additionally, in other embodiments, mobile device 140, during processing of transaction 202, may wirelessly transmit data to payment terminal device, including loyalty data or other identifiers, identification information, and/or account information, which may be encrypted, hashed, tokenized, or otherwise obscured so that a contact identifier, PII, or other identifying information is not exchange in clear or plain text. This may be done via short-range wireless communications, such as an NFC tap, and may be based on a digital wallet and digital wallet data and preferences. As such, server backend 220 may receive such loyalty or other data when processing transaction 202, and use the data to directly push or provide notification 224 over a network connection (e.g. Internet or cellular network connection) to mobile device 140 without requiring routing through payment terminal device 110.

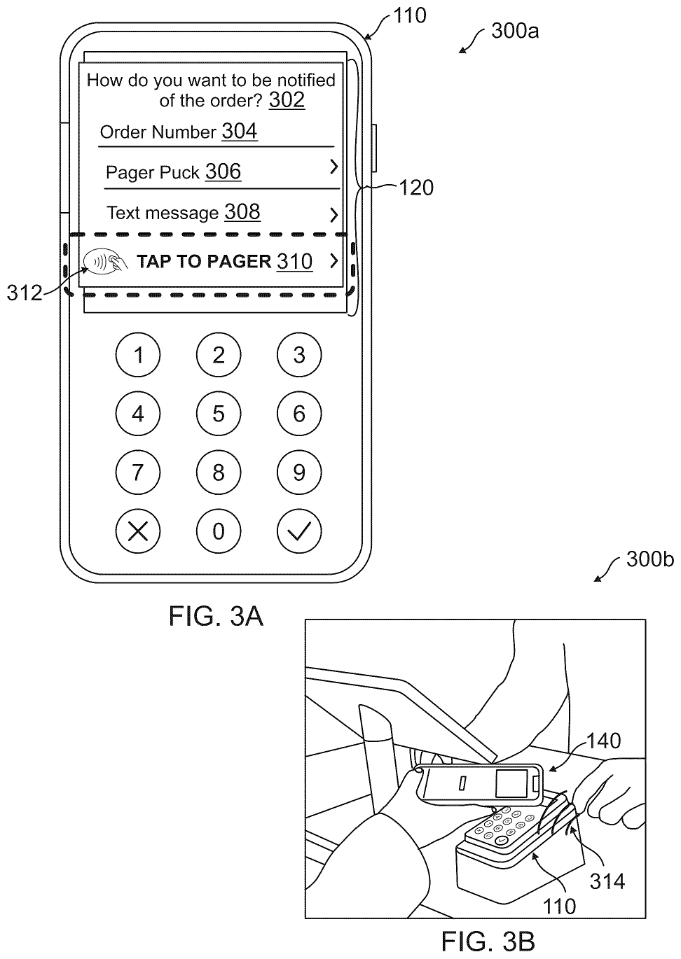

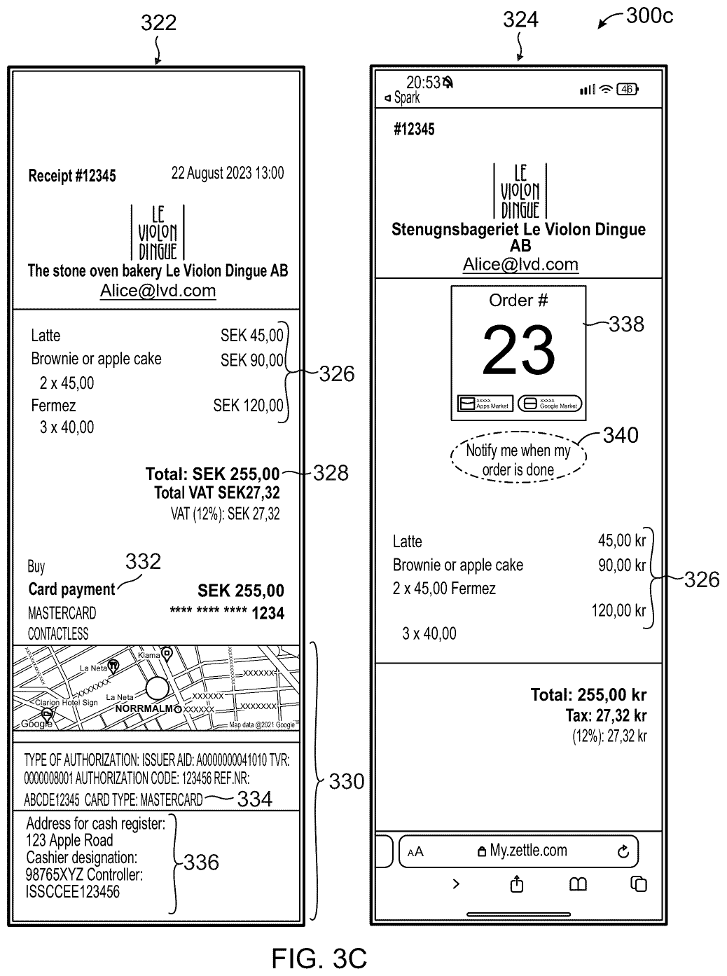

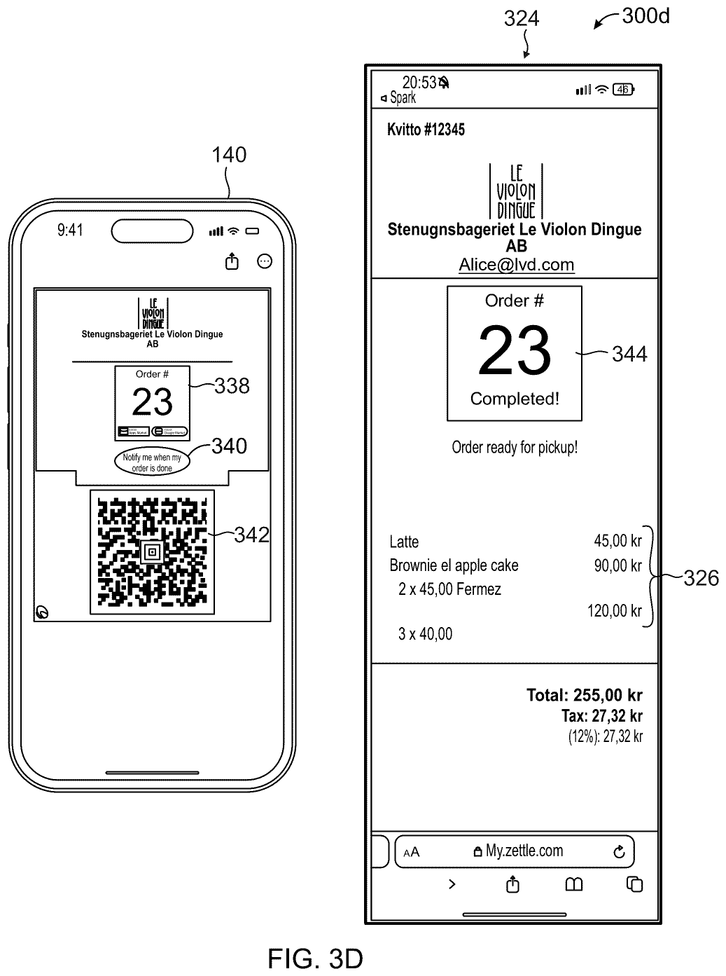

FIGS. 3A-3D are exemplary diagrams 300a-300d of payment terminals and mobile devices with corresponding user interface interacting to provide order notifications on the mobile devices, according to an embodiment. For example, diagrams 300a-300d include payment terminal device 110 interacting with mobile device 140, discussed in reference to system 100 of FIG. 1, to facilitate transmission of an order notification via a “tap-to-pager” feature of payment terminal device 110 without requiring a contact identifier or other user information. In this regard, different user interfaces and user interactions to facilitate this data exchange and paging via notifications in user interfaces are shown in diagrams 300a-300d.

In diagram 300a, payment terminal device 110 is shown displaying an order tracking interface 302 of payment processing application 120 after completing a transaction and requesting whether provision of a “page” or order notification may be performed on mobile device 140, effectively converting mobile device 140 to a pager or other notification device, specific to the order, for order status tracking and updating when fulfillment is complete. For example, payment terminal device 110 may correspond to a card reader that may allow a user to enter or provide a payment instrument for payment processing with a corresponding transaction with a user. In some embodiments, payment terminal device 110 may correspond to a PAYPAL ZETTLE® payment terminal or device. Once payment has been provided and processed, payment processing application 120 may transition to an interface that requests whether the user would like a notification to be provided on the user's device. A merchant or the user may then select an option in order tracking interface 302 to provide the notification to the user through one or more communication channels, objects, or mediums, where entry may be made through an input component (e.g., keypad or keyboard, touch screen, etc.).

Order tracking interface 302 in diagram 300a displays four options for order tracking and notifying, although less, more, or different options may also be displayed. For example, an order number 304 in order tracking interface 302 may cause display of an order number for a user to view and receive, as well as printing of an order and/or receipt via a corresponding printer or other component to provide a physical receipt, such as a paper copy of the receipt and order number 304 for the corresponding transaction.

A pager puck option 306 in order tracking interface 302 may allow the user to receive a physical “puck” or limited use device that provides a notification via visual, sound, or haptic feedback when an order is completed, and a signal is transmitted to the puck or other device. Text option 308 allows the user to enter or select a phone number or other contact identifier for text message receipt of a notification and/or alert. Order tracking interface 302 further provides a “tap-to-pager” option 310 that allows the user to receive the notification after performing a “tap” or placing their device within a short-range proximity while an NFC, RFID, or other signal is being broadcast for a data exchange that facilitates loading of data on mobile device 140 for a pager and notification. Tap-to-pager option 310 further includes an instruction icon 312 designating that the data is to be transmitted via NFC or other short-range wireless communications, and therefore a user should tap, or otherwise place, their corresponding device within a short proximity range to payment terminal device 110 to allow for data transmission and detection of a broadcast of the digital version or copy of the receipt.

In this regard, order number 304 merely provides a physical receipt that can be lost or damaged, while pager puck option 306 requires a dedicated device and system including “puck” devices that can be lost or stolen, are limited to a range within a merchant location, and are generally unfavorable or obtrusive to users. Text option 308 requires a user to provide a contact identifier, such as an email address or phone number respectively, that would compromise the user's anonymity and allow the merchant or others to perform unwanted outreach and communications (e.g., advertisement, spam, customer surveys, etc.). As such, tap-to-pager option 310 allows the user to digitally receive a page or other notification on the user's device, such as a mobile or wearable device, without providing information that would allow the merchant or another entity to contact the user and provide unwanted communications. Tap-to-pager option 310 thus provides an enhanced level of digital privacy and security to user's online identities and contact addresses or identifiers.

In diagram 300b, tap-to-pager option 310 from diagram 300a has been selected and instruction icon 312 has informed the user to bring their computing device, shown as mobile device 140 or a mobile phone (although a wearable device, tablet, or other portable or moveable computing device may also be used), into a proximity range for short-range wireless communications (e.g., using NFC or similar protocols). A message on payment terminal device 110 may be encoded with, have embedded data for, or otherwise contain information for the notification and/or used to access the notification, such as a URL, URI, file path, or the like. For example, the digital receipt may be generated as a data file or object, which may be loaded via a webpage or user interface having a corresponding webpage address or other link, which may allow storing, hosting, and providing the webpage or user interface to an application for display and output. Such address may be added or embedded to a message field, where the message field includes or causes an executable process on mobile device 140 to load or prompt the user to load the webpage address and navigate to the webpage in a browser application on mobile device 140.

In this regard, a notification may be generated in HTML and provided over a network as a webpage, may be encoded in an XML file and stored where the HTML encoded webpage may serve as an online backup, may be encoded or provided in a file or message type and sent directly, or may be encoded or provided in a larger file size, such as a Portable Network Graphics (PNG) image type file or the like. In this regard, data size constraints of the file and communication channel (e.g., NFC alone or with network communications using links and locators) may be used to select a file type and/or transmission process. Further, the user may select an option to receive and accept the message, file, and/or notification, which may be used to select the file type and/or transmission process.

Thereafter, the message may be transmitted through short-range wireless communications, where the message may be transmitted through broadcast 314. Broadcast 314 may correspond to a short-range transmission by a component on payment terminal device 110 that occurs continuously or periodically over a time period and allows for conveyance of the message to mobile device 140. In this regard, mobile device 140 may detect broadcast 314, which may cause the webpage and/or application data to load on mobile device 140 when received via broadcast 314 or after providing loyalty data or other user/account information back to payment terminal device 110. If broadcast 314 is not detected, payment terminal device 110 may repeat or continue transmission of broadcast 314 based on one or more commands or may instead move to display a barcode or QR code having encoded data for the digital receipt. Such transmission mechanisms may therefore not require the user to enter a contact identifier.

In diagram 300c, a receipt 322 is shown as may be generated, printed, and/or stored by a transaction processor and merchant POS system or device. In this regard, a receipt interface 324 may be loaded on a computing device, such as mobile device 140. In this regard, an application is shown with receipt interface 324 displaying receipt 322 via a webpage, message, application user interface or the like, for the corresponding digital version of a transaction receipt. The received message from payment terminal device 110 through broadcast 314 via short-range wireless communications may have caused the application to navigate to and load receipt 322 in receipt interface 324. The digital receipt may be loaded from a webpage data file and/or application interface data file, and receipt 322 may be displayed in receipt interface 324.

In this regard, receipt 322 includes a transaction 326 having a total 328, which has been processed and paid for as shown in a transaction history 330. Transaction history 330 includes a card payment 332 with an authorization 334 and merchant checkout information 336, which may be used for generation of a notification associated with paging a user when an order for transaction 326 is prepared, ready, or otherwise fulfilled. In this regard, based on receipt 322, receipt interface 324 may be generated and presented on a computing device of a user to provide the notification to the user that tracks order fulfillment and/or alerts the user when the order is fulfilled. For example, in receipt interface 324, an order number 338 is provided based on receipt 322 and an order tracking and/or fulfillment system, alerts, and/or updates for order statuses of the corresponding merchant. With order number 338, a pager option 340 may be provided whereby receipt interface 324 may be updated when the order is ready. As such, pager option 340 allows the user to be notified when the order is ready, which may be updated by the merchant system for ordering, tracking, and fulfillment.

In diagram 300d, mobile device 140 is shown on the right with receipt interface 324 presented having order number 338 with pager option 340. In this regard, mobile device 140 may act as a pager or other device that alerts the user when a corresponding order is ready, and therefore eliminates the need to pager “pucks” or other short-range limited using notification devices. In some embodiments, a QR code 342, or other displayable code, may be captured by mobile device 110 when a short-range wireless transmission is unavailable, which may include encoded data that links to receipt 322 and/or the pager notification to output receipt interface 324. As such, when an order is ready, receipt interface 324 is shown updated in the left of diagram 300d where order number 338 has been updated to have an updated order status 344 presenting the completion of the order, and therefore availability to pick up or retrieve using order number 338. In this manner, mobile device 140 may be converted to and/or used as the pager for pager notifications, which provides improved alert and notification systems to merchants and at merchant locations.

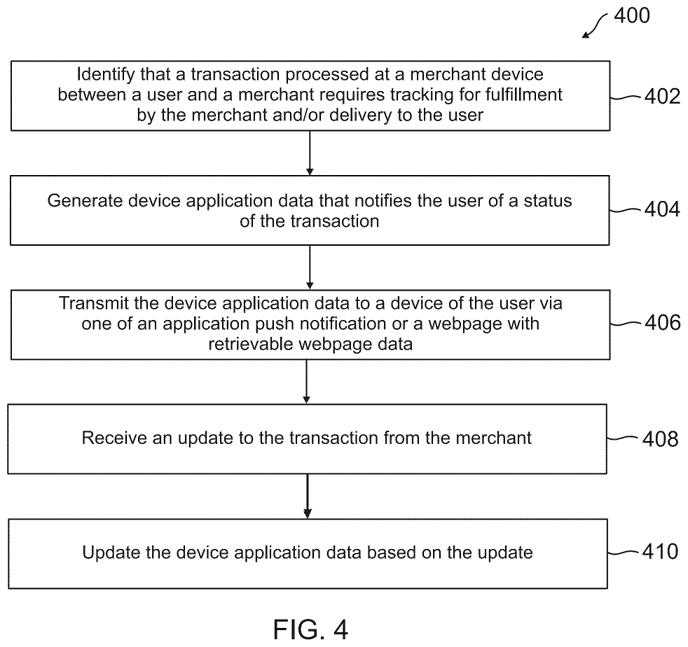

FIG. 4 is a flowchart 400 of an exemplary process for short-range transmission of receipt data without contact identifiers, according to an embodiment. Note that one or more steps, processes, and methods described herein of flowchart 400 may be omitted, performed in a different sequence, or combined as desired or appropriate.

Flowchart 400 in FIG. 4 includes steps executed by transaction processor 130 with payment terminal device 110 and mobile device 140, such as when providing pager notifications to mobile device 140. As such, different portions of the steps of flowchart 400 are shown as being performed by, on, or with payment terminal device 110, transaction processor 130, and mobile device 140.

At step 402 of flowchart 400, it is identified that a transaction processed at a merchant device between a user and a merchant requires tracking for fulfillment by the merchant and/or delivery to the user. For example, payment terminal device 110 in system 100 of FIG. 1 may receive transaction data, such as from user input, data scans, and/or communications, and process the transaction with transaction processor 130. In some embodiments, mobile device 140 may also provide and/or process the transaction data, such as by providing a digital token or payment information for payment processing. Such interactions may also be shown by payment terminal device 110, mobile device 140, and server backend 220 in system environment 200 of FIG. 2. A user may enter into a transaction at a physical merchant location, such as a merchant storefront or retail location. There, the user may initiate and process a transaction with a corresponding merchant device including POS devices, merchant payment terminals, self or automated checkout registers, and other merchant checkout and payment devices. The user may pay for one or more items or services and may then provide a payment instrument for transaction processing and completion.

On completion (e.g., payment processing and approval or declination based on insufficient funds, fraud detection or risk assessments, etc.), the merchant's device used for checkout and payment may display or output an option to provide a receipt to the user, which records the transaction or otherwise provides a history of the transaction (e.g., time, date, merchant information, items/services, prices and other costs or totals, etc.). The transaction may also include an order for items/services, which require fulfillment by the merchant. For example, the merchant may be required to prepare, deliver, and/or provide pick-up for the items/services. To track the order, the merchant may offer the user an option to receive notifications via mobile device 140, which may be done so by having mobile device 140 “tap” or brought near payment terminal device 110 for data exchange.

At step 404, device application data that notifies the user of a status of the transaction is generated. Payment terminal device 110 in system 100 and system environment 200 may receive a request for the notification on mobile device 140, and thereafter request that transaction processor 130 generate a notification and/or data that may be used to track the status and notify the user of the status via mobile device 140. To track the status and provide the status on mobile device 140, payment terminal device 110 may not require the user to enter a contact identifier, such as a name, phone number, email address, or the like. This may further ensure and protect the privacy of the user and limit or minimize spam and other unwanted communications by the merchant or another entity that may receive and/or access the user's preferred contact identifier.

A webpage and/or data file for the notification and status tracking maybe generated by creating a PDF file, image and/or image file (e.g., PNG, JPEG, etc.), or the like that may include information from the transaction and a field that may be updated and/or is dynamic to track data that for the order from the merchant's ordering and/or fulfillment system. As such, the device application data may correspond to different webpage and/or application interface data that may be displayed in an application on the user's mobile device. In this regard, a webpage may be generated as an XML or HTML file, which may be accessible and loaded when navigating to a webpage address. Other data containers, files, and online addresses may also be utilized. For example, application interface data may be generated that may be populated in an application of the merchant and/or transaction processor, as well as pushed to the mobile device of the user. As such, a data file and link, address, or identifier may be generated that allows for notifying a user of an order status and tracking order fulfillment by a web browser application or other software application on the user's mobile device.

An address or link and file may enable transmitting, providing, and/or loading the notification on a computing device, such as a mobile device of a user. For example, a webpage address or link to a webpage with a webpage file (e.g., HTML or XML) may be created, however other files and formats also be used. The data may be hosted via a webpage and/or stored in an online storage, such as a cloud-based or other large data storages that may store data with corresponding identifiers allowing for data retrieval. A message may also be generated for transmission using a short-range wireless protocol and messaging format, such as NDEF or the like. The message may be generated by adding, embedding, or otherwise providing the address, link, or other identifier for retrieval of the notification via the webpage or application data. For example, a message protocol for short-range wireless communications may allow the webpage address, a link, and/or executable command or operation to be embedded, added, or included in a field. The field may correspond to a header, message body, or the like, and may cause the message to open an application and load the digital receipt or navigate to the webpage and/or application interface data.

At step 406, the device application data is transmitted to a device of the user via one of an application push notification or a webpage with retrievable webpage data. For example, payment terminal device 110 in system 100 of FIG. 1 may broadcast, or otherwise transmit in a directed or undirected manner, a message (e.g., NFC tap message) for the device application data to mobile device 140. Broadcasting may be performed for a set period of time over the short-range wireless communications using a corresponding short-range wireless protocol. In this regard, a wireless transceiver of the payment terminal, POS device, or other merchant device may begin to transmit the message, such as continuously or periodically, for a time period with an instruction for the user to place their mobile, wearable, or other device within a proximity to merchant's device. The option to extend or rebroadcast may also be provided on the merchant's device at or near the end of the broadcast. If transmission and receipt of the message and corresponding digital receipt is not performed or does not occur, such as if the mobile device cannot or does not receive the message, another option to transmit the message and/or digital receipt may occur. For example, payment terminal device 110 may display a barcode or QR code that includes encoded data for the webpage and/or application interface.

At step 408, an update to the transaction is received from the merchant. The update may include a change to the status of the transaction, which may be provided by payment terminal device 110 and/or a merchant system, such as a merchant ordering and/or fulfillment system. In this regard, as the status is updated and changed, the notification and/or status data in or on the notification (e.g., in a field on a webpage or located on an interface in a corresponding field or element) may be updated. As such, at step 410, the device application data is updated based on the update. The device application data may be updated and changed to reflect the new status of the order, such as if the order is ready, completed, available for pickup, or the like. In this regard, the webpage accessed by the device or application interface displayed by the device may be automatically reloaded or refreshed to display the update to the status, which may the “page” or alert the user of the order's changed status. In another embodiment, the merchant system may be able to detect when or if the order has been picked up, which can be done manually through an employee or automatically through sensors. Once the order has been picked up, a subsequent notification may be sent to the user. However, if the order has not been picked up, the merchant system may send reminders to the user device at various intervals or frequencies until the order has been picked up.

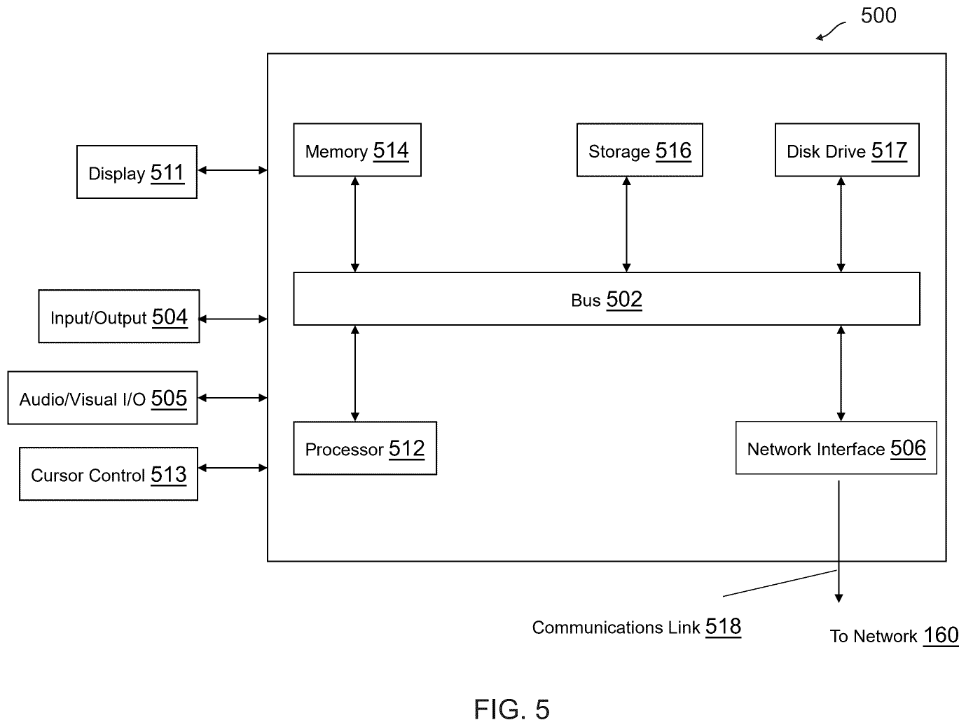

FIG. 5 is a block diagram of a computer system 500 suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows. For example, payment terminal device 110, transaction processor 130, mobile device 140, POS device 150, and/or one or more of the servers, devices, or other components in system 100 of FIG. 1 may be implemented by computer system 500.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 160. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

1. A method comprising:
receiving an indication that a transaction was processed at a merchant device between a user and a merchant, wherein the transaction includes an order for the merchant to fulfill for the user, and wherein the indication includes a transaction identifier usable to track a status of whether the transaction has been fulfilled;
generating notification data for the transaction that tracks the status using the transaction identifier, wherein the notification data is displayable via at least one of an application interface or a webpage;
transmitting a notification associated with the notification data to one of the merchant device of the merchant or a mobile device of the user;
providing the notification data via the notification in the at least one of the application interface or the webpage without requiring an identifier of the mobile device or the user;
receiving, from the merchant device, an update to the status of the transaction based on the transaction identifier; and
updating the notification data provided via the notification based on the update.

2. The method of claim 1, wherein the providing the notification data comprises:
generating the webpage and a webpage address for the webpage based on the notification data, wherein the webpage includes the transaction and the status accessible via the webpage address for viewing; and
hosting the webpage over a network for access using the webpage address.

3. The method of claim 2, wherein, prior to the receiving the update, the method further comprises:
transmitting, to the merchant device, code having the webpage address embedded in the code.

4. The method of claim 3, wherein the code comprises at least one of a near field communication (NFC) data token comprising an executable command that loads the webpage using the webpage address without requiring a message file attachment or a quick response (QR) code that includes displayable encoded data for the webpage address.

5. The method of claim 1, wherein the indication further comprises loyalty data for the user from a digital wallet on the mobile device of the user, wherein the loyalty data is received with a payment from the digital wallet for the transaction, and wherein the loyalty data is linked to at least the status for tracking on behalf of the user.

6. The method of claim 5, wherein, prior to the transmitting the notification, the method further comprises:
determining an identifier associated with the user based on the loyalty data, wherein the notification is transmitted to the mobile device using the identifier.

7. The method of claim 1, wherein the identifier is associated with an account of the user accessible via a mobile application on the mobile device, and wherein the notification comprises an in-application notification published in the mobile application using the identifier.

8. The method of claim 1, wherein the order is for a good or a service that requires fulfillment at a merchant location of the merchant where the transaction takes place, and wherein the update to the status includes at least one of a prepared order number or order retrieval instructions provided via the notification data based on the updated notification data.

9. A system comprising:
a non-transitory memory; and
one or more hardware processors coupled to the non-transitory memory and configured to execute instructions to cause the system to:
receive, from a merchant system, account data for a user and a first status of a transaction processed between the user and a merchant corresponding to the merchant system, wherein the first status indicates the transaction is pending a fulfillment of the transaction by the merchant and is usable to track the fulfillment of the transaction by the merchant;
generate notification data for the transaction that tracks a progress of the fulfillment of the transaction between the first status and at least one subsequent status, wherein the notification data is displayable via at least one of an application interface or a webpage displayable in an application on a mobile device of the user;
determine an account of the user based on the account data;
transmit the notification data to the user via the account, wherein transmitting the notification causes the application on the mobile device to display the notification data; and
update the notification data based on the at least one subsequent status when received.

10. The system of claim 9, wherein the account data is received from the merchant system when processing the transaction based on a payment instrument provided by the mobile device to the merchant system.

11. The system of claim 10, wherein the payment instrument comprises a digital wallet token or a payment card token from a digital wallet on the mobile device, and wherein the account data is tokenized or encrypted when transferred to the merchant system with the digital wallet token or the payment card token.

12. The system of claim 9, wherein generating the notification data comprises:
generating one of application interface data for the application interface or webpage data for the webpage based on the transaction and the first status.

13. The system of claim 9, wherein the notification data is transmitted to the user via the account using a push notification to the application when the application is logged in to the account.

14. The system of claim 9, wherein the notification data is transmitted over a network to the mobile device separately from merchant system, and wherein the merchant system is prevented from receiving an identifier associated with the user or the account when transmitting the notification data.

15. The system of claim 9, wherein the at least one subsequent status comprises a second status indicating the fulfillment of the transaction is completed and instructions for receiving one or more items and/or one or more services for the transaction.

16. The system of claim 9, wherein the merchant system comprises one of a standalone payment terminal in communication with the system over a network or a merchant POS device and a connectable payment terminal in communication with the merchant POS device.

17-20. (canceled)

21. A non-transitory machine-readable medium having stored thereon machine-readable instructions executable to cause a machine to perform operations comprising:
receiving an indication that a transaction was processed at a merchant device between a user and a merchant, wherein the transaction includes an order for the merchant to fulfill for the user, and wherein the indication includes a transaction identifier usable to track a status of whether the transaction has been fulfilled;
generating notification data for the transaction that tracks the status using the transaction identifier, wherein the notification data is displayable via at least one of an application interface or a webpage;
transmitting a notification associated with the notification data to one of the merchant device of the merchant or a mobile device of the user;
providing the notification data via the notification in the at least one of the application interface or the webpage without requiring an identifier of the mobile device or the user;
receiving, from the merchant device, an update to the status of the transaction based on the transaction identifier; and
updating the notification data provided via the notification based on the update.

22. The non-transitory machine-readable medium of claim 29, wherein the providing the notification data comprises:
generating the webpage and a webpage address for the webpage based on the notification data, wherein the webpage includes the transaction and the status accessible via the webpage address for viewing; and
hosting the webpage over a network for access using the webpage address.

23. The non-transitory machine-readable medium of claim 30, wherein, prior to the receiving the update, the operations further comprise:
transmitting, to the merchant device, code having the webpage address embedded in the code.

24. The non-transitory machine-readable medium of claim 29, wherein the code comprises at least one of a near field communication (NFC) data token comprising an executable command that loads the webpage using the webpage address without requiring a message file attachment or a quick response (QR) code that includes displayable encoded data for the webpage address.
